(19) United States
(12) Patent Application Publication
(10) Pub. No.: US 2025/0076171 A1
(43) Pub. Date: Mar. 6, 2025

(54) DEVICE FOR DETERMINING A RHEOLOGICAL PROPERTY OF A SUSPENSION OF MATERIAL COMPRISING FIBERS FOR PRODUCING CONTAINERS

(71) Applicant: Krones AG, Neutraubling (DE)

(72) Inventor: Jörg ZACHARIAS, Koefering (DE)

(21) Appl. No.: 18/814,343

(22) Filed: Aug. 23, 2024

(30) Foreign Application Priority Data
Aug. 28, 2023 (DE) 10 2023 123 081.6

(51) Int. Cl. G01N 11/10

(52) U.S. Cl. CPC G01N 11/10

(57) ABSTRACT

A device for determining a rheological property of a suspension of material comprising fibers for producing containers, comprising a tank for storing the suspension of material comprising fibers and a control unit, wherein the tank comprises a stirring device for stirring the suspension of material comprising fibers and the control unit is designed to determine a rheological property of the suspension of material comprising fibers based on an interaction between the stirring device and the suspension of material comprising fibers.

### CROSS REFERENCE TO RELATED APPLICATION

The present application claims priority to German Patent Application No. 10 2023 123 081.6 filed on Aug. 28, 2023. The entire contents of the above-listed application are hereby incorporated by reference for all purposes.

### TECHNICAL FIELD

The present disclosure relates to a device for determining a rheological property of a suspension of material comprising fibers for producing, and a corresponding method.

### BACKGROUND

Methods and devices for producing containers from material comprising fibers are well known in the prior art.

### SUMMARY

However, more detailed information regarding the mixing process of the suspension used to produce the containers from material comprising fibers or the characterization of the suspension cannot be found in the prior art. However, in order to be able to produce containers of sufficiently high quality, the precise characterization of the suspension of material comprising fibers provided for container production plays an important role.

Therefore, in the prior art the suspension of material comprising fibers is typically mixed in a stirring device for a certain given time interval in order to evenly disperse the solid and liquid portions and to reduce the particle size of the material comprising fibers. However, a precise characterization of the suspension of material comprising fibers with regard to its physical properties and/or exact composition does not exist in the prior art. Rather, the quality of the suspension is only determined empirically, for example by visual inspection by an operator.

However, this procedure has the disadvantage that it cannot be determined exactly whether the suspension of material comprising fibers has been sufficiently dispersed, has a desired concentration of solids or liquid, and/or a certain degree of swelling of the solids component. Consequently, the quality of the suspension of material comprising fibers produced with the stirring device cannot be clearly determined. This in turn means that the production of containers with consistently high quality cannot be guaranteed, and containers of inferior quality are also produced.

### Object

Based on the known prior art, the technical object to be achieved by the present disclosure is to present a method and a device which allow the quality of a suspension of material comprising fibers for producing containers to be determined in a precise manner.

### Solution

This object is achieved by the device for determining a rheological property of a suspension of material comprising fibers for producing containers and the method for determining a rheological property of a suspension of material comprising fibers for producing containers.

The device according to the disclosure for determining a rheological property of a suspension of material comprising fibers for producing containers comprises a tank for storing the suspension of material comprising fibers and a control unit, wherein the tank comprises a stirring device for stirring the suspension of material comprising fibers, and the control unit is designed to determine a rheological property of the suspension of material comprising fibers based on an interaction between the stirring device and the suspension of material comprising fibers.

The rheological property of the suspension of material comprising fibers is understood to mean a flow property and/or a deformation property of the suspension of material comprising fibers. For example, the rheological property can be a viscosity, dilatancy or structural viscosity with and without a yield point. However, it can also be any other rheological property not explicitly mentioned here. It can also be provided that more than one rheological property, in particular two, three or more rheological properties, are determined.

A material comprising fibers can, for example, mean renewable and/or recycled natural materials based on plants, such as cellulose-containing materials, wherein it can in particular be natural fibers such as plant fibers, paper fibers or wood fibers. The fibers can also be or comprise flakes. The fibers can also have different dimensions and/or shapes. For example, the suspension can also comprise fibers with a specific particle size distribution. The material comprising fibers can also contain non-sustainable components such as synthetic or metallic fibers. Optionally, the material comprising fibers is pulp or paper maché. However, it can also be any other material comprising fibers suitable for producing a container.

The suspension of material comprising fibers can also comprise, in addition to the fibers, water and a binding agent. However, the suspension can also comprise other components, such as additives or other fillers. The additive can, for example, comprise glue, thixotropic agent, hydrophobizing agent or any other additive which strengthens a wall of the container made of material comprising fibers, positively affects the labelability of the container, and/or creates a liquid, light and/or gas barrier in the container, and/or beneficially affects the processability of the material comprising fibers, for example improving the precoatability of the material comprising fibers. The filling material can be, for example, starch, chalk, biocides or any other filling material.

The container can be a bottle used in the beverage industry, wherein this type of design is not to be understood as limiting. The suspension of material comprising fibers can also be suitable for producing any other type of container. For example, the container can also be a can, tube or cup used in the beverage, pharmaceutical, healthcare or food industries, or any other type of container.

The stirring device for stirring the suspension of material comprising fibers can be designed to uniformly disperse liquid and solid components of the suspension. The stirring device can also be designed to reduce the particle size of the solid components during stirring. To disperse and comminute the solid components of the suspension, the stirring device can comprise a stirring tool.

Interaction is understood to mean an interaction between the stirring device and the suspension of material comprising fibers which causes at least partial mixing of the suspension of material comprising fibers in the tank. The interaction can, for example, be a force exerted on a surface of the suspension by the stirring device. For example, it can be a shear stress. It can also be operating parameters of the stirring device which are directly linked to the shear stress. The interaction can also be a shear rate of the suspension caused by the stirring device. It can also be operating parameters of the stirring device which are directly linked to the shear rate.

Since the rheological property of the suspension of material comprising fibers is directly linked to a processing state, for example a physical parameter, of the suspension of material comprising fibers, it can be determined in a simple and precise manner whether the suspension has a desired processing state by determining the rheological property. For example, by using the rheological property, it can be determined whether the suspension is sufficiently dispersed and the swelling process of a solid component of the suspension and/or the crosslinking process of an additive is concluded. By means of the rheological property, the concentration of the material comprising fibers and/or the liquid phase of the suspension of material comprising fibers can also be determined. Based on the specific processing state, a clear characterization of the suspension can be made, and its quality can also be assessed as sufficient or insufficient, for example by means of a binary yes or no decision. Since the quality of the suspension in turn correlates with the quality of the containers made from the suspension, their precise characterization is of great importance.

In one embodiment, the rheological property can be a viscosity of the suspension of material comprising fibers. During the dispersion or mixing of the suspension and the swelling process of the solids contained in the suspension, the viscosity changes. Once the suspension is sufficiently dispersed and the swelling process is concluded, the viscosity assumes a constant value. The viscosity is therefore a suitable parameter to clearly characterize the processing state of the suspension.

In one embodiment, the interaction can be a torque, a power consumption, or a current consumption that must be applied by the stirring device in order to achieve a certain rotational speed of the stirring device when stirring the suspension, and/or a rotational speed of the stirring device that can be achieved with a given torque, a given power consumption, or a given current consumption. These measured variables can be directly linked to a rheological property, such as viscosity, and therefore represent particularly suitable parameters for determining the rheological property.

In one embodiment, the control unit can be designed to determine a change in the rheological property within a certain time interval. By determining a change in the rheological property over time, information about the temporal progression of a processing state of the suspension of material comprising fibers can be obtained.

In one embodiment, the control unit can be designed to determine an equilibrium value of the rheological property of the suspension of material comprising fibers if the change in the rheological property within the specific time interval lies below a first threshold value. If the liquid and solid components of the suspension are completely dispersed and the swelling process of the solid components is finished, the rheological property converges towards a constant or changes only slightly over time. By measuring the rheological property, it can therefore be precisely determined when the suspension is sufficiently dispersed and the swelling process is concluded.

In one embodiment, a solid content and/or a liquid content of the suspension of material comprising fibers can be changed if the equilibrium value deviates from a target value by at least a second threshold value. Even if the suspension is sufficiently dispersed and the swelling process is concluded, it may be that the solid and/or liquid content was set too low or too high. By comparing with the target value, information about the composition of the suspension can be obtained and corrected if necessary.

In one embodiment, the device can comprise an apparatus for producing a container, wherein the tank is connected to the apparatus for producing the container via a discharge line, and the suspension of material comprising fibers can be fed to the apparatus for producing the container when the equilibrium value deviates from a target value by less than a second threshold value. In this way, it can be ensured that only a suspension of material comprising fibers which has a desired processing state or a sufficient quality is fed to the apparatus for production, and it can be ensured that containers of consistently high quality are produced with the apparatus.

In the method according to the disclosure for determining a rheological property of a suspension of material comprising fibers for producing containers, the suspension of material comprising fibers is stored in a tank and stirred in the tank by means of a stirring device, wherein a rheological property of the suspension of material comprising fibers is determined by means of a control unit based on an interaction between the stirring device and the suspension of material comprising fibers.

Since the rheological property provides clear information about the processing state of the suspension of material comprising fibers, measuring the rheological property represents a simple and precise way to characterize the suspension with regard to a desired processing state or a desired quality.

In one embodiment, the rheological property can be a viscosity of the suspension of material comprising fibers. Since the viscosity correlates, among other things, with the degree of dispersion and a solid content of the suspension, the degree of swelling of a solid content of the suspension and/or a particle size distribution of the suspension, it represents a particularly suitable parameter for determining a processing state of the suspension or its quality.

In one embodiment, the interaction can be a torque, a power consumption, or a current consumption that is applied by the stirring device in order to achieve a certain rotational speed of the stirring device when stirring the suspension, and/or a rotational speed of the stirring device that can be achieved with a given torque, a given power consumption, or a given current consumption. These measured variables can be directly linked to a rheological property, such as viscosity, and therefore represent particularly suitable parameters for determining the rheological property.

In one embodiment, it can be provided that the control unit determines a change in the rheological property within a certain time interval. By determining a change in the rheological property over time, information about the temporal progression of a processing state of the suspension of material comprising fibers can be obtained.

In one embodiment, it can be provided that an equilibrium value of the rheological property of the suspension of material comprising fibers is determined by the control unit if the change in the rheological property within the certain time interval lies below a first threshold value. If the suspension is sufficiently dispersed and/or a swelling process of a solid content of the suspension is concluded, the rheological property converges towards a constant. By measuring the rheological property, it can be precisely determined when the suspension is sufficiently dispersed and the swelling process is concluded.

In one embodiment, it can be provided that a solids content and/or a liquid content of the suspension of material comprising fibers is changed if the equilibrium value deviates from a target value by at least a second threshold value. Even if the suspension is sufficiently dispersed and the swelling process is concluded, it may be that the solid and/or liquid content was set too low or too high. By comparing with the target value, information about the composition of the suspension can be obtained and corrected if necessary.

In one embodiment, it can be provided that the suspension of material comprising fibers is fed from the tank to an apparatus for producing the container via a discharge line if the equilibrium value deviates from a target value by less than a second threshold value. In this way, it can be ensured that only a suspension of material comprising fibers which has a desired processing state or a sufficient quality is fed to the apparatus for producing the container, and therefore ensures that containers of consistently high quality are produced with the apparatus.

In one embodiment, it can be provided that the discharge line comprises a pumping device for conveying the suspension of material comprising fibers from the tank to the apparatus for producing the container, and the rheological property of the suspension of material comprising fibers in the discharge line is determined for quality control by means of an energy consumption of the pumping device, and/or wherein the line comprises a sensor, and the rheological property of the suspension of material comprising fibers in the discharge line is determined for quality control by means of the sensor. By quality control of the suspension of material comprising fibers, an additional control mechanism can be implemented to ensure that the suspension has a sufficiently high quality when it is fed to the apparatus for producing the container.

### BRIEF DESCRIPTION OF THE FIGURES

FIG. 1 shows a device for determining a rheological property of a suspension of material comprising fibers for producing containers according to an embodiment;

FIG. 2 shows a device for determining a rheological property of a suspension of material comprising fibers for producing containers according to another embodiment

### DETAILED DESCRIPTION OF THE FIGURES

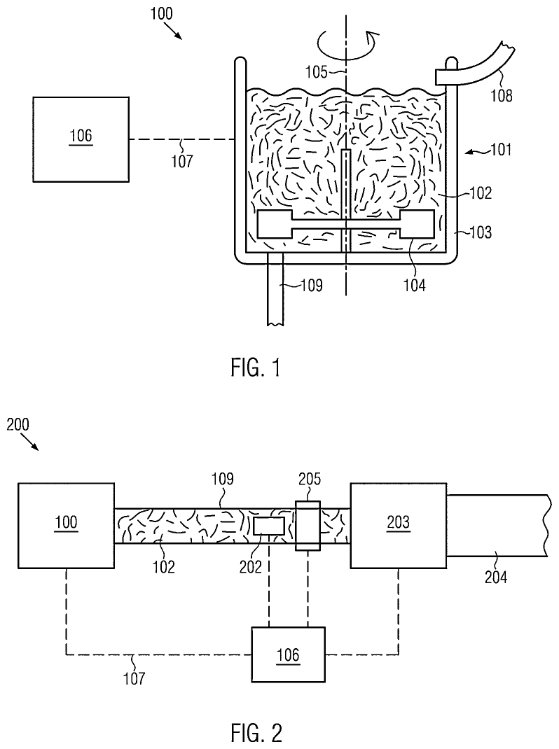

FIG. 1 shows a device 100 for determining a rheological property of a suspension of material comprising fibers 102 for producing containers according to an embodiment.

According to the disclosure, the device 100 comprises a tank 101 for storing the suspension of material comprising fibers 102 and a control unit 106. The tank 101 in turn comprises a stirring device 104 for stirring the suspension of material comprising fibers 102. The tank 101 can comprise a tank body 103 into which the stirring device 104 can be lowered. The control unit 106 is designed according to the disclosure to determine a rheological property of the suspension of material comprising fibers 102 based on an interaction between the stirring device 104 and the suspension of material comprising fibers.

Optionally, the tank 101 can comprise a supply line 108 for the suspension of material comprising fibers 102. While in connection with the embodiment described in FIG. 1, an optional feed line 108 is provided, in an alternative embodiment, several optional feed lines 108, such as 2, 3 or 5 feed lines, can be provided, via which the various components of the suspension 102, such as liquid and solid components, can be fed separately to the tank 101. This has the advantage that the solid or liquid content of the suspension can be flexibly adjusted. Also optionally, a discharge line 109 can be provided, by means of which the suspension of material comprising fibers 102 can be discharged from the tank 101. The arrangement of the feed line 108 and discharge line 109 shown in FIG. 1 is to be understood as exemplary. The feed and discharge lines can also be arranged at any other position of the tank 101. Furthermore, the tank 101 can comprise an optional external circulation line, by means of which the suspension of material comprising fibers stored in the tank 101 can be additionally circulated. Optionally, the circulation line can comprise a sensor for determining a rheological property of the suspension of material comprising fibers.

The upwardly open design of the tank body 103 and its shape are also to be understood as exemplary. The tank body 103 can also take any other shape and, for example, be closed at the top, whereby a possible contamination of the suspension of material comprising fibers 102 stored in the tank 101 can be prevented.

The rheological property of the suspension of material comprising fibers 102 is understood to mean a flow property and/or a deformation property of the suspension of material comprising fibers 102. The rheological property can be, for example, a viscosity, dilatancy or structural viscosity with and without yield point. However, it can also be any other rheological property not explicitly mentioned here. It can also be provided that more than one rheological property, in particular two, three or more rheological properties, are determined.

A material comprising fibers can, for example, mean renewable and/or recycled natural materials based on plants, such as cellulose-containing materials, wherein it can in particular be natural fibers such as plant fibers, paper fibers or wood fibers. The fibers can also be or comprise flakes. The material comprising fibers can also contain non-sustainable components such as synthetic or metallic fibers. Optionally, the material comprising fibers is pulp or paper maché. However, it can also be any other material comprising fibers suitable for producing a container.

The suspension of material comprising fibers 102 can also comprise, in addition to the material comprising fibers, water and a binder. However, the suspension can also comprise other components, such as additives. The additive can be for example glue, thixotropic agent, hydrophobizing agent or any other additive which strengthens a wall of the container made of material comprising fibers, positively affects the labelability of the container, creates a liquid, light and/or gas barrier, and/or improves the processability of the suspension of material comprising fibers, such as precoatability.

The container may be a bottle used in the beverage industry. However, it can also be any other container, such as a can, tube or cup used in the beverage, pharmaceutical, healthcare or food industries.

An interaction is understood to mean an interaction between the stirring device 104 and the suspension 102 which causes at least a partial mixing of the suspension of material comprising fibers 102 in the tank 101. The interaction can, for example, be a force exerted on a surface of the suspension by the stirring device. For example, it can be a shear stress. It can also be operating parameters of the stirring device which are directly linked to the shear stress. The interaction can also be a shear rate of the suspension caused by the stirring device. It can also be an operating parameter of the stirring device, which is directly linked to the shear rate.

In the embodiment described in FIG. 1, the stirring device 104 is designed as a disk stirrer which can be rotated about an axis 105. This specific type of design of the stirring device 104 can advantageously affect the dispersion process of the suspension of material comprising fibers 102. In an alternative embodiment, the stirring device 104 can also be designed, for example, as an inclined blade, propeller, anchor or spiral stirrer. Any other type of design of the stirring device 104 not explicitly listed here which is suitable for dispersing the solid and liquid components of the suspension of material comprising fibers can also be provided. In one embodiment, it can also be provided that more than one stirring device 104 is provided in the tank 101.

The control unit 106 can be designed as a computer or server system and can be connected via a cable or wireless connection 107 to the various components of the device 100, which components can be controlled or regulated and/or from which data can be read out. Component can, for example, mean the tank 101 or the stirring device 104. For example, the control unit 106 can be designed to read out or control or regulate an operating parameter of the stirring device 104, such as a torque, a rotational speed, a current consumption and/or a power input and also any other operating parameter of the stirring device 104 not explicitly listed here. Furthermore, the control unit 106 can be designed to regulate a specific operating parameter of the stirring device 104 such that a specific rotational speed of the stirring device 104 can be achieved when stirring the suspension of material comprising fibers and/or to regulate the rotational speed of the stirring device 104 such that a specific value of the operating parameter can be achieved.

According to the disclosure, the control unit 106 is designed to determine a rheological property of the suspension of material comprising fibers 102 based on an interaction between the stirring device 104 and the suspension of material comprising fibers 102.

The interaction can, for example, be a torque, a power consumption or a current consumption that must be applied by the stirring device in order to achieve a certain rotational speed of the stirring device when stirring the suspension and/or a rotational speed of the stirring device that can be achieved with a given torque, a given power consumption or a given current consumption.

The control unit 106 can comprise a memory device. A database can be stored in the memory device, wherein in the database, a corresponding rheological property can be assigned to at least one interaction between the stirring device 104 and the suspension of material comprising fibers 102. For example, at least a certain torque that is necessary to achieve a certain rotational speed of the stirring device 104 can be assigned a corresponding viscosity value. Accordingly, a corresponding viscosity value can also be assigned to at least one current consumption and/or at least one power input which is necessary to achieve a certain speed of the stirring device 104. At least one rheological property of the suspension of material comprising fibers can in turn be assigned to a specific processing state of the suspension in the database. The processing state can comprise, for example, a solid concentration, a degree of dispersion, a degree of swelling of the suspension of material comprising fibers, and/or a degree of crosslinking of an optional additive. At least one processing stage of the suspension of material comprising fibers can in turn be assigned a specific quality value of the suspension in the database. For example, the quality value can be classified binarily as sufficient or insufficient. Therefore, the control unit can be designed not only to determine a rheological property based on the interaction, but also to determine a processing state or a quality of the suspension. The precise characterization of the suspension and the determination of its quality is a fundamental prerequisite for being able to produce containers of consistently high quality using the suspension 102.

In one embodiment, it can be provided that the control unit 106 comprises an artificial intelligence and the interaction between suspension and material comprising fibers, for example a torque which the stirring device 104 must apply in order to achieve a certain rotational speed of the stirring device 104, is fed to the artificial intelligence as a parameter. The artificial intelligence can be designed to determine the rheological property based on this parameter. In one embodiment, it can be provided that the artificial intelligence determines a processing state of the suspension based on the rheological property, for example a degree of dispersion of the suspension, a degree of swelling of a solid fraction contained in the suspension and/or a degree of crosslinking of an additive optionally contained in the suspension. The artificial intelligence can also be designed to determine whether the processing state corresponds to a desired processing state and whether the suspension has a desired quality. The artificial intelligence can be trained using different interaction data sets that were measured in different suspensions of material comprising fibers of different compositions and/or different processing states. In one embodiment, artificial intelligence can be a neural network.

Alternatively, it can also be provided that the control unit 106 comprises a deterministic algorithm to which the interaction between the stirring device 104 and the suspension of material comprising fibers 102 can be made available as a parameter and which can determine a rheological property of the suspension 102 based on the provided parameters. The deterministic algorithm can also be designed to determine a processing state and/or a quality of the suspension based on the rheological property. The above control unit may include instructions stored in the memory device, such as computer memory, for carrying out the operations described herein according to the approaches described herein.

In one embodiment, the rheological property can be a viscosity of the suspension 102. The viscosity is a particularly suitable rheological variable for determining and checking a processing state of a suspension of material comprising fibers or for making a statement about the quality of a suspension of material comprising fibers. This is due to the fact that the viscosity of the suspension 102 changes during the dispersion or mixing of the suspension 102 and during the swelling process of the solids contained in the suspension 102, or during a crosslinking process of additives optionally contained in the suspension. If, however, the suspension is sufficiently dispersed and the swelling or crosslinking process is concluded, the viscosity converges to a constant value so that by measuring the viscosity, it can be determined in a particularly precise manner whether the suspension 102 has a desired processing state or a desired quality.

To determine the rheological parameter, for example the viscosity, it can be provided in one embodiment that a torque, a power consumption or a current consumption is determined by means of the control unit 106 which must be applied by the stirring device in order to achieve a certain speed of the stirring device 104. Alternatively, it can also be provided that the control unit 106 determines a rotational speed of the stirring device, which can be achieved with a given torque, a given power consumption or a given current consumption. For this purpose, the control unit 106 can, for example, access the database stored in the storage unit. In addition, the control unit 106 can use generally known physical relationships to determine the rheological property, as briefly explained below using the example of viscosity, torque and speed.

For the viscosity η, the following relationship applies:

$$η = \frac{τ}{\dot{γ}}$$

where τ describes the shear stress and \dot{γ} the shear rate, wherein the shear stress τ is proportional to the torque M applied by the stirring device 104, and the shear rate is proportional to the rotational speed n at which the stirring device 104 is rotated to stir the suspension 102.

If the control unit 106 then determines the torque which must be applied by the stirring device 104 in order to achieve a certain rotational speed, for example 60 revolutions per minute, 120 revolutions per minute, 240 revolutions per minute or 360 revolutions per minute, the control unit 106 can determine the viscosity of the suspension of material comprising fibers 102 by means of the relationship given above.

Alternatively, it can also be provided that the control unit 106 sets a given torque M of the stirring device 104 and determines the rotational speed n at which the stirring device 104 is rotated, and can determine the viscosity of the suspension of material comprising fibers 102 based on the relationship given above.

Since the viscosity of the suspension of material comprising fibers 102 correlates, among other things, with a degree of dispersion of the suspension 102, a solid content of the suspension 102, a degree of swelling of a solid content of the suspension 102 and/or a degree of crosslinking of an additive optionally contained in the suspension, this represents a particularly suitable parameter for determining a processing state of the suspension 102 or a quality of the suspension. In particular, the value of the viscosity changes over time when the dispersion, swelling and/or crosslinking process is not yet fully concluded, and converges towards a constant value when the dispersion, swelling and/or crosslinking process is concluded. For example, it is known that with increased swelling of the material comprising fibers, the viscosity of the suspension of the material comprising fibers increases and converges to a constant when the swelling process of the material comprising fibers is concluded. This relationship can also be observed for other rheological properties.

The measurement of the temporal progression of the rheological property, such as the viscosity, therefore represents a particularly suitable method for monitoring the processing state of the suspension of material comprising fibers 102, or for determining when the suspension 102 has reached a desired processing state and/or a certain quality. By determining the temporal progression of the rheological parameter based on the interaction between the suspension of material comprising fibers 102 and the stirring device 104 and using the data stored in the database of the storage unit and/or generally known physical relationships, the control unit 106 can therefore determine whether a desired processing state of the suspension 102 has been reached, or whether further stirring of the suspension 102 is necessary to achieve the desired processing state. Therefore, the processing time of the suspension of material comprising fibers can also be optimized.

For this purpose, the control unit 106 can be designed to determine an equilibrium value of the rheological property of the suspension of material comprising fibers 102 if the change in the rheological property within the specific time interval lies below a first threshold value. As already described above, the rheological property converges to a constant value when the dispersion, swelling and/or crosslinking process is concluded. If there is only a slight change in the rheological property over time, for example a change per minute which can be less than 1% or less than 0.1%, or less than 0.01% of an absolute value of the rheological property, the control unit 106 can determine that the suspension is in an equilibrium state and the dispersion, swelling and/or crosslinking process is concluded.

In some cases, however, it can also happen that the suspension 102 is sufficiently dispersed, and the dispersion, swelling and/or crosslinking process is concluded, but the suspension does not have a desired solid and/or liquid concentration. For example, the solids content of the suspension can be too high or too low. To take this case into account, the control unit 106 can be designed to compare the equilibrium value with a target value stored in the database, which allows it to be determined whether the suspension 102 has a desired solid and/or liquid concentration. If the control unit 106 determines during the comparison that the equilibrium value deviates from the target value by at least a second threshold value, then the control unit 106 can determine that the solid or liquid concentration does not correspond to a desired value, and a solid content and/or a liquid content of the suspension of material comprising fibers is changed.

If the control unit 106 establishes that the determined equilibrium value deviates from the target value by less than the second threshold value, then the control unit 106 can be designed to determine that the suspension of material comprising fibers 102 has reached a desired processing state.

The suspension 102 can then, for example, be fed to another device for further processing. For this purpose, the suspension can be discharged from the device 100 via the discharge line 109. Optionally, a valve can be arranged at an outlet of the tank 101 to which the discharge line 109 is connected. If the control unit 106 establishes, as in the just described case, that the quality of the suspension 102 is sufficient, the control unit 106 can be designed to open the valve so that the suspension can be discharged from the tank 101 via the discharge line 109.

This case is described in more detail in connection with FIG. 2.

FIG. 2 shows a device 200 for determining a rheological property of a suspension of material comprising fibers for producing containers according to another embodiment.

In addition to the device 100 described in connection with FIG. 1, the device 200 comprises an apparatus 203 for producing a container from the suspension of material comprising fibers 102, wherein the suspension 102 can be fed via discharge line 109 to the apparatus for producing the container 203. For this purpose, a pumping device 205 for conveying the suspension of material comprising fibers 102 can be provided in the discharge line 109. Furthermore, in the discharge line 109, a sensor 202 for determining a rheological property of the suspension of material comprising fibers 102 can be arranged in the discharge line 109.

According to the embodiment described in connection with FIG. 1, the control unit 106 can also be connected to the controllable and/or readable components of the device 200 shown in FIG. 2 via a wired or wireless connection 107. For example, the control unit 106 can be connected to the device 100, the pumping device 205, the sensor 202 and/or the apparatus for producing the container 203.

For quality control of the suspension 102 fed from the device 100 to the discharge line 109, it can be provided that the control unit 106 is designed to determine an energy consumption of the pumping device 205 for conveying the suspension of material comprising fibers 102, and to determine a rheological property of the suspension of material comprising fibers 102 based on the energy consumption of the pumping device 205. As already described above in connection with the stirring device 104, the rheological property of the suspension also correlates with the energy consumption of the pumping device through which the suspension 102 is conveyed. Consequently, the control unit 106 can also determine a rheological property of the suspension of material comprising fibers 102 based on the energy consumption and therefore determine a processing state and/or a quality of the suspension of material comprising fibers 102. Since the composition of the suspension 102 and/or its processing state in the discharge line 109 can no longer be changed, a quality control of the suspension of material comprising fibers 102 can be carried out by determining the energy consumption by means of the pumping device 205 before it is fed to the apparatus for producing the container 203.

Additionally or alternatively, a quality control of the suspension can be carried out via the sensor 202 arranged in the discharge line 109. In one embodiment, the sensor 202 can be a designed sensor, such as a Coriolis mass flow sensor. By means of the Coriolis mass flow sensor, for example, a viscosity and/or density of the suspension 102 can be determined and, based thereon, a processing state of the suspension 102 can be determined by the control unit 106, and a quality control of the suspension 102 provided by the device 100 can be performed.

In one embodiment, it can be provided that the control unit 106 is designed to interrupt the supply of the suspension of material comprising fibers 102 from the device 100 to the apparatus for producing the container 203 if the control unit 106 determines, based on the rheological property determined by the energy consumption of the pumping device 205 and/or that determined by the sensor 202, that the processing state of the suspension of material comprising fibers 102 does not correspond to a desired processing state, or the quality of the suspension of material comprising fibers 102 does not correspond to a desired quality. In this case, it can be provided that the suspension of material comprising fibers 102 is fed back into the device 100 by means of the pumping device 205 and is further stirred, and/or a liquid or solid content of the suspension is changed until the desired processing state and/or the desired quality of the suspension 102 is achieved.

Additionally or alternatively, it can also be provided that the discharge line 109 is connected to the tank 101 or the device 100 via a return line, and the suspension of material comprising fibers, or a part of the suspension of material comprising fibers can be guided from the discharge line 109 via the return line back into the tank 101. Furthermore, it can be provided that the suspension of material comprising fibers can be circulated via the return line through the discharge line 109 and the tank 101. This can then be provided, for example, when no suspension of material comprising fibers is to be made available to the apparatus for producing the container 203. In this case, the circulation of the suspension can ensure that the suspension of material comprising fibers in the discharge line 109 remains homogeneous, and that the material comprising fibers does not settle in the discharge line 109. Optionally, the return line can comprise a sensor which can be designed to determine a first processing state or a first quality of the suspension of material comprising fibers returned via the return line. The control unit can optionally be designed to compare the first processing state or the first quality of the returned suspension of material comprising fibers with a second processing state or a second quality of the suspension located in the tank, and to determine whether the first processing state or the first quality of the returned suspension corresponds to a determined processing state or a determined quality value.

If, on the other hand, it is determined based on the energy consumption of the pumping device 205 and/or by means of the sensor 202 that the suspension 102 has a desired processing state or that the quality of the suspension 102 has a desired value, then the suspension of material comprising fibers can be further fed to the apparatus 203.

By means of the quality control in the discharge line 109, even in the event of an error in determining the quality of the suspension in the tank 101, it can be ensured that only a suspension of sufficiently high quality is fed to the apparatus for producing the container 203, and the quality of the containers produced by means of the apparatus for producing the container 203 can be ensured.

In one embodiment, the apparatus for producing the container 203 can comprise a mold. The mold can in turn comprise a perforated cavity, which can represent a negative impression of the container to be produced. To produce the container, it can be provided that the mold is charged with the suspension 102 supplied from the device 100 via the discharge line 109. Due to the perforation of the mold and an overpressure prevailing in the mold, there is an accumulation of the material comprising the fibers on the wall of the mold, while the liquid component of the suspension is led out of the mold through the perforation. The apparatus 203 can further comprise a component for curing the suspension of material comprising fibers. This can be, for example, a heat, infrared or microwave oven, by means of which the suspension deposited on the wall of the mold can be exposed to electromagnetic radiation of the corresponding wavelength.

Downstream from the apparatus for producing the container 203, a transport device 204 can optionally be provided for removing the containers made of material comprising fibers produced by the apparatus 203. By means of the transport device 204, the produced containers can be transferred, for example, to a downstream device for treating the containers, such as a labeling machine, a filler, a sealer or any other device that is suitable for treating containers. Alternatively, it can also be provided that the containers produced by means of the apparatus 203 are fed to a storage apparatus by means of the transport device 204.

In one embodiment, it can also be provided that a plurality of apparatuses for producing the containers 203 are connected to the device 100 via corresponding discharge lines 109. For example, it can be provided that 5, 10, or 50 apparatuses for producing containers 203 are in connection with the device 100. Therefore, the container throughput can be increased by the device 200.

1. A device for determining a rheological property of a suspension of material comprising fibers for producing containers, comprising a tank for storing the suspension of material comprising fibers and a control unit, wherein the tank comprises a stirring device for stirring the suspension of material comprising fibers and the control unit is designed to determine a rheological property of the suspension of material comprising fibers based on an interaction between the stirring device and the suspension of material comprising fibers.

2. The device according to claim 1, wherein the rheological property is a viscosity of the suspension of material comprising fibers.

3. The device according to claim 1, wherein the interaction is a torque, a power consumption or a current consumption which must be applied by the stirring device in order to achieve a certain speed of the stirring device when stirring the suspension and/or a speed of the stirring device which can be achieved with a given torque, a given power consumption or a given current consumption.

4. The device according to claim 1, wherein the control unit is designed to determine a change in the rheological property within a certain time interval.

5. The device according to claim 4, wherein the control unit is designed to determine an equilibrium value of the rheological property of the suspension of material comprising fibers when the change in the rheological property within the certain time interval is below a first threshold value.

6. The device according to claim 5, wherein a solid content and/or a liquid content of the suspension of material comprising fibers can be changed if the equilibrium value deviates from a target value by at least a second threshold value.

7. The device according to claim 5, comprising an apparatus for producing a container, wherein the tank is connected to the apparatus for producing the container via a discharge line and the suspension of material comprising fibers can be fed to the apparatus for producing the container when the equilibrium value deviates from a target value by less than a second threshold value.

8. A method for determining a rheological property of a suspension of material comprising fibers for producing containers, wherein the suspension of material comprising fibers is stored in a tank and stirred in the tank by means of a stirring device, wherein a rheological property of the suspension of material comprising fibers is determined by means of a control unit based on an interaction between the stirring device and the suspension of material comprising fibers.

9. The method of claim 8, wherein the rheological property is a viscosity of the suspension of material comprising fibers.

10. The method according to claim 8, wherein the interaction is a torque, a power consumption or a current consumption which is applied by the stirring device in order to achieve a certain speed of the stirring device when stirring the suspension and/or a speed of the stirring device which can be achieved with a given torque, a given power consumption or a given current consumption.

11. The method according to claim 8, wherein the control unit determines a change in the rheological property within a certain time interval.

12. The method according to claim 11, wherein an equilibrium value of the rheological property of the suspension of material comprising fibers is determined by the control unit when the change in the rheological property within the certain time interval is below a first threshold value.

13. The method according to claim 12, wherein a solid content and/or a liquid content of the suspension of material comprising fibers is changed when the equilibrium value deviates from a target value by at least a second threshold value.

14. The method according to claim 12, wherein the suspension of material comprising fibers is fed from the tank to an apparatus for producing a container via a discharge line if the equilibrium value deviates from a desired value by less than a second threshold value.

15. The method according to claim 14, wherein the discharge line comprises a pumping device for conveying the suspension of material comprising fibers from the tank to the apparatus for producing the container, and the rheological property of the suspension of material comprising fibers in the discharge line is determined for quality control by means of an energy consumption of the pumping device and/or wherein the discharge line comprises a sensor and the rheological property of the suspension of material comprising fibers in the discharge line is determined for quality control by means of the sensor.
